(19) United States
(12) Patent Application Publication
(10) Pub. No.: US 2008/0027805 A1
(43) Pub. Date: Jan. 31, 2008

(54) Mutually beneficial management system for website advertisements

(75) Inventor: Chia-Ming Chang, Taoyuan Hsien (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: SUNFUN INFO CO., LTD., George Town (KY)

(21) Appl. No.: 11/706,478

(22) Filed: Feb. 15, 2007

(30) Foreign Application Priority Data
Jul. 31, 2006 (TW) 095127966

(51) Int. Cl. G06Q 30/00

(52) U.S. Cl. 705/14

(57) ABSTRACT

A mutually beneficial management system includes an advertisement database, a member database, a value adding module, an advertisement posting management system, an advertisement playing module, and a bonus module. The advertiser posts an advertisement via the advertisement posting management system and transfer money in the value adding module to pay the charge for advertising. The advertisement is stored in the advertisement database. The advertiser may assign the advertisement to be playable by members with specific conditions. When a website member clicks the advertisement, the bonus module sends a bonus to the member. The value adding module charges to an advertiser's account or credit card account as the advertising cost. The website member clicking the advertisement can get a bonus and be attracted to check the advertisement. The advertiser benefits from this because the advertisement can be set for specific consumers who may potentially purchase the products.

### BACKGROUND OF THE INVENTION

1. Field of the Invention

The invention relates to a website advertisement management system and, in particular, to a software system that establish a mutually beneficial mechanism among the advertiser, website provider, and the website members (particularly the members who click the advertisement).

2. Description of Related Art

As the Internet gets more popular, websites have become a platform for various business activities. For example, many large entry website, such as Kimo-Yahoo, PCHOME, etc, not only provide website classifications and indexing/searching services, they also provide shopping and advertisement services owing to their large numbers of members. The advertisement charges are an important income for running the websites. However, the website advertisement effects have been questioned by people. This is because although the advertisement icons of the advertisers are posted at specific positions in the website, the entire advertisement content is displayed only when a user clicks the icons and links to the corresponding webpage. Unfortunately, users usually do not automatically click the advertisement icons. This is why a lot of people doubt that website advertising is a way to go.

Since the effects of website advertising are difficult to evaluate, advertisers often do not want to invest a lot in this. As a result, the advertisement income of the website providers cannot grow. This in turn affects the website service quality and thus the website users. In principle, a hot website with a lot of user should also be an ideal platform for advertising. However, current users do not have motivations to check the advertisements. Consequently, there is a negative impact on the website provider, the website users, and the advertisers.

For search engines such as Google, there are often competitors or search engine providers themselves clicking the advertisements to increase the cost of the advertiser. This is a waste and difficult to track. Also, there is no way to control the number of times and frequency that each website user clicks the advertisement.

### SUMMARY OF THE INVENTION

In view of the foregoing, the fact that web advertising is not very effective is the primary reason why advertisers still have reservations. This directly affects the income and service quality of the website. Therefore, it is imperative to study and improve the current web advertising mechanism.

An objective of the invention is to provide a mutually beneficial management system for website advertisements. For the advertisers, it can focus on certain users and ensure the advertising effects. For website providers, it can increase the advertisement income. For website members, it offers bonus for clicking the advertisements. Therefore, the invention provides a mutually beneficial management mechanism.

To achieve the above-mentioned objective, the management system has a member database and an advertisement database. It also generates a platform website for members to log in. Furthermore, the invention includes: an advertisement posting management module, an advertisement playing module, a value adding module, and a bonus module.

The advertisement posting management module produces an operating webpage for the advertiser to post advertisements and set conditions for consumers. The advertisement content is stored in the advertisement database.

The advertisement playing module is linked to the advertisement database and specific positions on the platform webpage. When a member clicks a specific position, the corresponding advertisement content is played.

The value adding module allows the advertiser to transfer money in a prepaid scheme. When the members click the advertisement, advertising charges are deducted from the advertiser's account.

The bonus module is linked to both the member database and the platform webpage. It offers bonuses to the members who click the advertisement.

Using the above-mentioned system design, the advertiser can set conditions to focus on specific consumers. That is, the advertisement can be set for members with specific backgrounds or conditions. The advertisements can thus be played for those members to maximize the advertising effects. The system is designed such that members who click the advertisement can receive bonuses that can be used to purchase merchandises. Therefore, the advertising effects can be further enhanced. On the other hand, the website provider charges according to the number of times an advertisement is checked. Therefore, the incomes increase with the number of clicking times. It is thus seen that the invention benefits the advertiser, the website provider, and the members.

The advertiser operating webpage of the advertisement posting management module includes at least the following fields:
Post a new advertisement/modify an old advertisement;
Set conditions of target consumers;
Select an advertisement position/type;
Set advertisement materials;
Set a posting period; and
Set an advertisement budget (cost of each click).

The advertisement posting management module further links to a to-be-reviewed advertisement database. The to-be-reviewed advertisement database links to the advertisement database for temporarily storing new advertisement content of the advertiser. The content is sent to the advertisement database for storage after it is reviewed.

The advertisement database further links to an advertisement statistics module, which in turn links to an advertisement position in the platform webpage for tracking the number of exposure times of an advertisement, the number of times an advertisement has been clicked, and the ranking of the advertisement position. Each advertiser can check the ranking record to bid for an advertisement position that has a higher ranking or higher appearance frequency by adjusting the cost per click (CPC) in the field of “set an advertisement budget”.

The advertisement statistics module also checks the clicking activities of members, generates the clicking points, and writes the information back to the member database. The bonus earned by the members is computed accordingly.

The advertisement database further links to an advertisement analysis module, which is used to analyze the advertising effects using the results obtained by the advertisement statistics module. Data and an analysis table are generated for the advertiser's reference.

### BRIEF DESCRIPTION OF THE DRAWINGS

FIG. 1 is a schematic view of a mutually beneficial management system in accordance with the present invention;

FIG. 2 is a schematic flowchart of the invention;

FIG. 3 is a flowchart showing how an advertisement posting management module of the present invention works; and

FIG. 4 is a flowchart showing an advertisement playing module of the present invention works.

### DETAILED DESCRIPTION OF THE PREFERRED EMBODIMENT

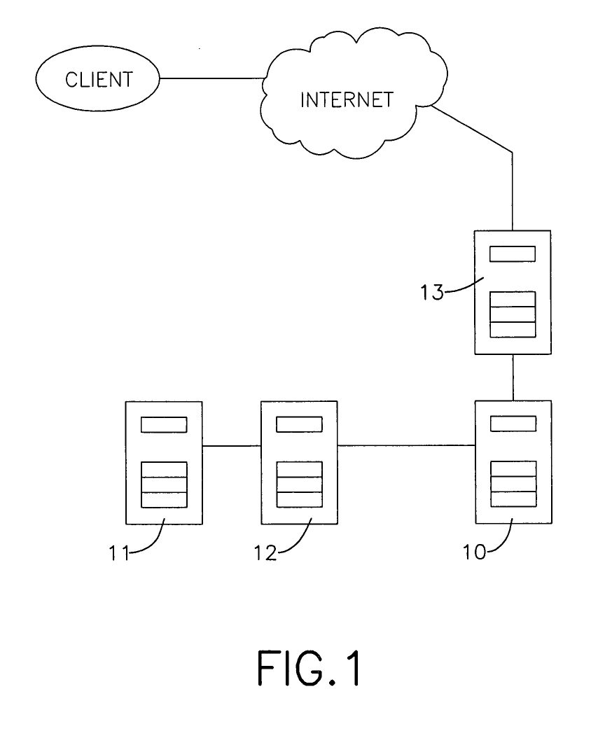

As shown in FIG. 1, an embodiment of the invention includes two sets of database hosts, a management host 10, and a network server 13. The two sets of database hosts are an advertisement database 11 and a member database 12, respectively, both of which are connected to the management host 10. The management host 10 further connects to the network server 13 to generate a platform webpage for a user to login and use.

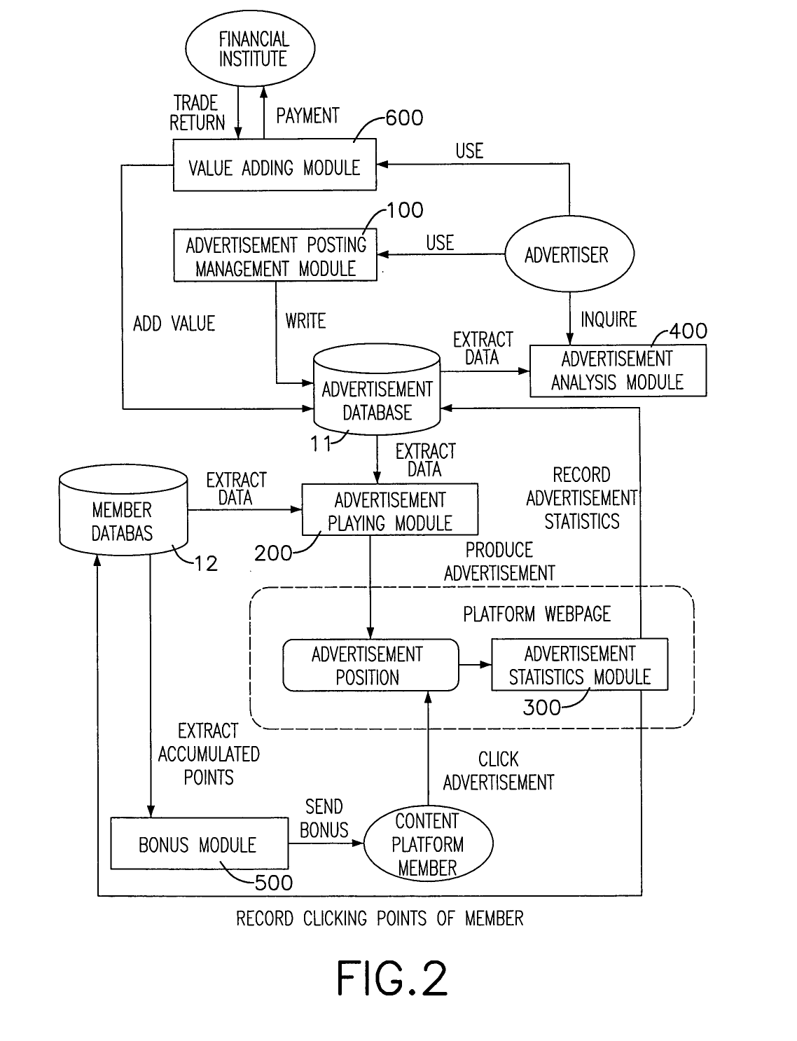

As shown in FIG. 2, the management host 12 includes at least an advertisement posting management module 100, an advertisement playing module 200, an advertisement statistics module 300, an advertisement analysis module 400, a bonus module 500, and a value adding module 600.

The advertisement posting management module 100 can generate an advertiser operating webpage for an advertiser to post an advertisement. The advertisement posting management module 100 connects to the advertisement database 11 for storing the advertisement content of the advertiser therein.

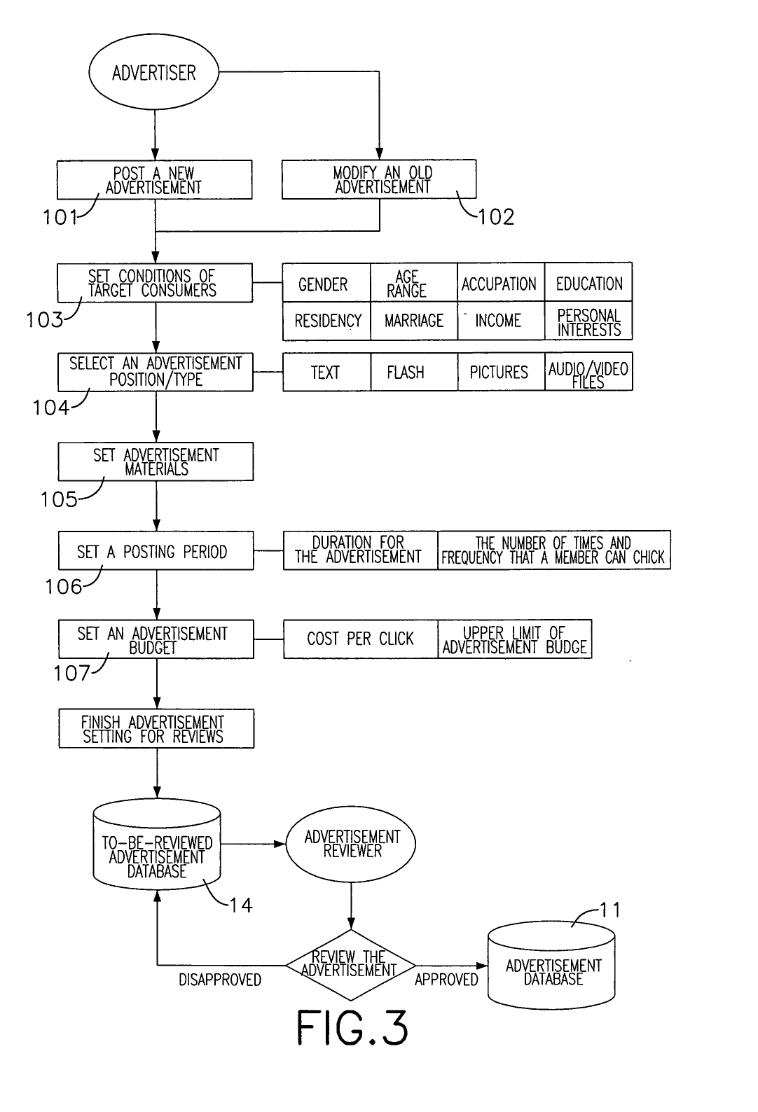

As shown in FIG. 3, the advertiser operating webpage of the advertisement posting management module 100 contains the following setting/selection fields:

Post a new advertisement 101/modify an old advertisement 102;

Set conditions of target consumers 103: The basic information of members belonging to the platform webpage is classified according to the following conditions: gender, age ranges, occupation, education, residency, marriage status, income, personal habit. The advertiser can set the conditions of target consumers accordingly. When some member satisfies the conditions set by the advertiser enters the platform webpage, it automatically shows those advertisements that are designed for the member to click. This achieves the objective of precision marketing for the advertiser.

Select an advertisement position/type 104: This allows an advertiser to select an advertisement position in the platform webpage and sets the media types that constitute the advertisement, such as text, flash, pictures, and audio/video files.

Set advertisement materials 105: The advertiser can upload advertisement materials or edit the current advertisements.

Set a posting period 106: This allows an advertiser to set a duration for the advertisement and to set the number of times and frequency that a member can click the advertisement.

Set an advertisement budget 107: This allows each advertiser to set a cost per click (CPC). According to the advertisement cost (CPC×the number of total clicks), charges are deducted from the account of the advertiser by the value adding module 600. Once the account balance is zero, the advertisement is no longer displayed. If the advertisement cost (CPC×the number of total clicks) reaches the upper limit of the advertisement budget set by the advertiser, the advertisement is not displayed either. The value adding module 600 can be replaced by an automatic credit card deduction mechanism.

In addition to the above-mentioned setting/selecting fields, the advertiser operating webpage of the advertisement posting management module 100 links to a to-be-reviewed advertisement database 14. The to-be-reviewed advertisement database 14 further links to the advertisement database 11. The to-be-reviewed advertisement database 14 is used to temporarily store the new advertisement content posted by the advertiser. Once the advertisement content is reviewed, it is sent to the advertisement database 11 for storage.

As shown in FIG. 2, the advertisement playing module 200 is connected to the advertisement database 11 and the advertisement position of the platform webpage, so that the advertisement content of the assigned link is played when a member clicks the advertisement position.

Furthermore, the advertisement database 11 and the member database 12 are connected to an advertisement statistics module 300, which then connects to the advertisement position on the platform webpage for recording the number of exposures of each advertisement position, the number of clicks, and the ranking of the advertisement positions. Each advertiser can check the ranking record to bid for an advertisement position that has a higher ranking or higher appearance frequency by increasing the CPC in the field of “set an advertisement budget” 107 of the advertisement posting management module 100. The order and appearance frequency of an advertisement at an advertisement position is related to the advertisement budget set by the advertiser. The higher the CPC is, the more prominent position and the more frequent the advertisement appears. In other words, the advertiser obtains a better advertisement position and a higher appearance frequency using a higher advertisement budget. The website also has a higher profit. Moreover, the advertisement statistics module 300 also checks the advertisement clicking activities of members, generates the clicking points, and writes the information back to the member database 12.

The bonus module 500 connects to the member database 12 and the platform webpage. It sends a bonus to the member when the member clicks an advertisement. How much bonus the member can obtain by clicking the advertisement is determined by clicking points computed by the advertisement statistics module 300 according to the clicking activities thereof.

The value adding module 600 is provided for the advertiser to transfer money in a prepaid scheme. It deducts advertising cost from the advertiser's account as members click the advertisement.

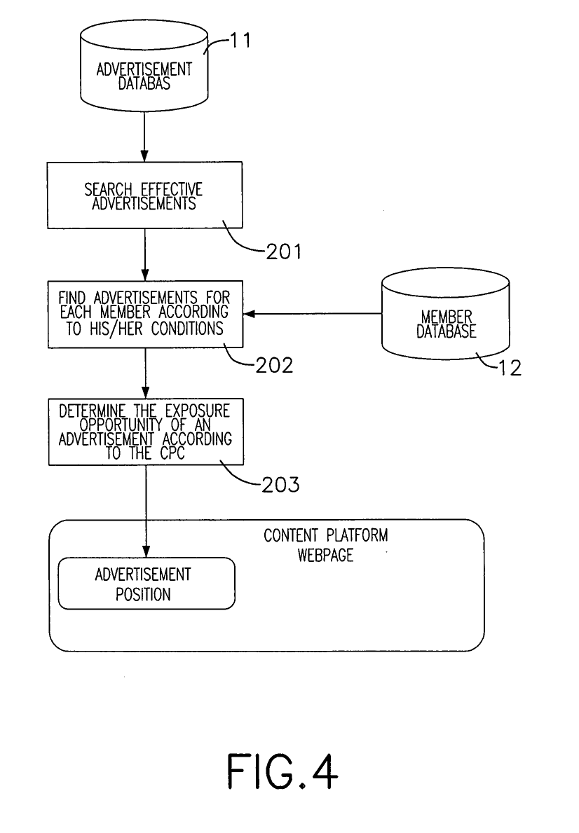

FIG. 4 discloses a procedure of the advertisement playing module 200. It includes the following steps.

In step 201, effective advertisements are searched. Such effective advertisements include those still within the posting period, yet reaching the advertisement budget upper limit, or whose advertiser still have a sufficient balance in the account.

Step 202 finds advertisements for each member according to his/her conditions. When each member browses the webpage, advertisements are selected and posted thereon according to the conditions of member (including the gender, age range, occupation, education, residency, marriage status, income, personal interests). For example, suppose some member registers as an electrical engineer and shows personal interests in digital electronics, then the advertiser for 3C products can consider such people as potential customers for marketing. This does not only reduce the advertising range, but also greatly increases the effects.

Step 203 determines the exposure opportunity of an advertisement according to the CPC. If an advertisement position has several possible advertisements for a member, then the displayed order (or appearance frequencies) of the advertisements is determined by the CPC of each advertisement. Advertisements with the same CPC is played according to the time their advertisers place the bids.

In accord with the above-mentioned technical details, the invention can achieve mutual benefits. In the above-mentioned management system, an advertiser can set the conditions of the target consumers. That is, members of specific backgrounds or conditions in the website are selected to view the advertisements. Using this method, the advertisements are played to potentially interested consumers, thereby maximizing the advertising effects. The system is also designed such that a member can obtain a bonus by clicking an advertisement, and the bonus can be used to purchase merchandises or on additional services of the website. Therefore, members have motivations and are encouraged to click advertisements. The advertising effects are thus further increased. Using this scheme also prevents competitors or the search engine provider to click the advertisement, resulting in wastes in the advertiser's budget. On the other hand, the website provider charges according to the number of times the advertisements are clicked. A large number of clicking times of course help increasing the income. Consequently, the invention achieves the goal of mutual benefits for the advertiser, the website provider, and the members.

What is claimed is:

1. A mutually beneficial management system for website advertisements having a member database and an advertisement database and generating a platform webpage with advertisement positions for members to log in, the system comprising:
an advertisement posting management module generating an advertiser operating webpage for an advertiser to post an advertisement and to set conditions for target consumers, the advertisement being stored in the advertisement database;
an advertisement playing module connecting to the advertisement database and linking to the advertisement positions on the platform webpage so as to play the advertisement of an assigned link when a member clicks an advertisement position on the platform webpage;
a value adding module, which is used for the advertiser to create a account and to transfer money in a prepaid scheme, and deducts an advertising cost from the account when the member clicks the advertisement; and
a bonus module connecting to the member database and the platform webpage and sending a bonus to the member when he/she clicks the advertisement;
wherein when the member logs into the platform webpage, advertisements for members of specific conditions appear at the advertisement positions on the platform webpage.

2. The system as claimed in claim 1, wherein the advertiser operating webpage of the advertisement posting management module comprises selection fields of:
posting a new advertisement/modifying an old advertisement;
setting conditions of target consumers;
selecting an advertisement position/type;
setting advertisement materials;
setting a posting period; and
setting an advertisement budget.

3. The system as claimed in claim 2, wherein the advertisement posting management module further links to a to-be-reviewed advertisement database that in turn links to the advertisement database so that the to-be-reviewed advertisement database temporarily stores a new advertisement posted by the advertiser and sends the new advertisement to the advertisement database for storage once the new advertisement is reviewed.

4. The system as claimed in claim 3, wherein the advertisement database further links to an advertisement statistics module that in turn links to the advertisement positions on the platform webpage for recording a total number of exposures of each advertisement in the corresponding advertisement position, a number of clicks, and a ranking of the advertisement positions; and each advertiser refers to the ranking record and bids for an advertisement position with a higher ranking or appearance frequency by increasing the cost per click (CPC) in the field of setting an advertisement budget of the advertisement posting management module.

5. The system as claimed in claim 4, wherein the advertisement statistics module checks the member's activities in clicking advertisements, generates clicking points, writes the information back to the member database, and computes a bonus for the member.

6. The system as claimed in claim 5, wherein the advertisement database links to an advertisement analysis module that analyzes effects of the advertisement according to results obtained by the advertisement statistics module and generates data and a table for the advertiser.

7. The system as claimed in claim 2, wherein the conditions of target consumers comprises gender, age range, occupation, education, residency, marriage status, income, and personal interests.

8. The system as claimed in claim 2, wherein the field of selecting an advertisement position/type of the advertiser operating webpage is used for the advertiser to select an advertisement position in the platform webpage and to set a media type for the advertisement content according to properties of the position.

9. The system as claimed claim 2, wherein the field of setting advertisement materials of the advertiser operating webpage is used for the advertiser to upload advertising materials and/or edit the advertising materials that are currently being posted.

10. The system as claimed in claim 2, wherein the field of setting a posting period of the advertiser operating webpage enables the advertiser to set an advertisement posting period, a number of times and a frequency that a member is allowed to repeatedly click the advertisement.

11. The system as claimed in claim 2, wherein the field of setting an advertisement budget of the advertiser operating webpage enables the advertiser to set the cost per click (CPC) and charges are deducted from an advertiser's account according to an advertising cost which is equal to (CPC)×(a number of total clicks of the advertisement).

12. The system as claimed in claim 4, wherein the advertisement playing module performs the steps of:
finding effective advertisements;
selecting advertisements for each member according to his/her conditions; and
determining an order of showing advertisements according to their CPC's.
